(19) United States
(12) Patent Application Publication
(10) Pub. No.: US 2011/0296625 A1
(43) Pub. Date: Dec. 8, 2011

(54) COMPOSITION

(75) Inventor: Giuseppe Di Bono, Mira (IT)

(73) Assignee: RECKITT BENCKISER N.V., Hoofddorp (NL)

(21) Appl. No.: 13/122,582

(22) PCT Filed: Sep. 29, 2009
(86) PCT No.: PCT/GB2009/002326

§ 371 Date: Jul. 22, 2011

(30) Foreign Application Priority Data
Oct. 7, 2008 (GB) 0818269.3

(51) Int. Cl. D06L 1/12; C11D 17/00

(52) U.S. Cl. 8/137; 510/337

(57) ABSTRACT

A cleaning composition comprises a dispersion. The dispersion includes an acidic aqueous phase and a suspended particle. The particle is coated with an acid stable coating

This invention relates to cleaning compositions and cleaning methods.

Consumers are aware that in order to achieve effective cleaning of household items a multitude of different cleaning agents have to be incorporated into a single cleaning composition. As examples bleaches are used to oxidise/decolourise stains; surfactants are used to solubilise grease and water softening agents are used to soften hard water.

One major problem with the preparation of a complex admixture of components is to ensure that all components are stabilised in the admixture so that they are not denatured between the point of manufacture and the point of use.

This problem is particularly prevalent wherein the detergent composition includes components which are antagonistic towards other detergent components. In this regard bleaches are case in point: typically they bring about oxidative destruction of many other detergent components. A further example is pH: often a pH which brings about stability of one component may bring about the eradication of another.

One way to address this problem is to keep the components having different storage requirements separate until their point of use. This is relatively facile when the both components are in solid form since a separate environment for the two components can easily be created. Thus cleaning powders and compressed particulate tablets can be produced which contain multiple ingredients in solid form. Additionally often the components requiring different storage environments are segregated with the composition as a further aid to prevent premature reaction.

However, certain cleaning preparations require the use of a liquid formulation. In such a case the facile separation solution cannot easily be achieved since the components are free to migrate within the liquid and will, if they come into contact, react with one another.

In this case traditionally it has been necessary to provide liquid cleaning formulations in multi-chamber packs, wherein one chamber contains one component and a second chamber contains another component, so that different storage environments are created and the components are only brought into contact at the point of use. Such twin chamber packs are expensive to manufacture and cumbersome in use, requiring an unnecessary burden of dexterity from a consumer.

It is an object of the present invention to obviate/mitigate the disadvantages described above.

According to a first aspect of the present invention there is provided a cleaning composition comprising a dispersion, including an acidic aqueous phase and a suspended particulate, wherein the particle is coated with an acid stable coating.

With the use of a composition in accordance with the present invention it has been found that a liquid formulation may be provided which displays excellent stability before use and outstanding performance in use due to the combination of coating and coated particle. Additionally the exceptional performance is imparted without the need for a complex multi-chamber sales pack.

The coating generally comprises an acid resistant coating such as (but not limited to) cellulose acetate phthalate, hydroxypropylmethylcellulose acetate succinate, hydroxypropylmethylcellulose phthalate, polyvinylacetate phthalate, carboxymethylcellulose, acrylic acid polymers and copolymers, methacrylic acid polymers and copolymers, methoxyethene copolymers.

Preferably the coating comprises a copolymer of acrylic acid and acrylic acid methyl ester or a copolymer of methacrylic acid and methacrylic acid methyl ester or a copolymer of methoxyethene and bicarboxylic acids anhydrides or mixtures thereof.

Most preferably the coating comprises a copolymer of acrylic acid methyl ester, methacrylic acid methyl ester and methacrylic acid or a copolymer of methoxyethene and maleic anhydride. Preferred commercially available examples of such coatings include Eudragit FS 30-D and Gantrez AN-169 BF.

Additives and auxiliary ingredients may be added to the coating. Typical additives are plasticizers, which improve the quality of the coating making it more flexible and thus adapting it to the surface texture and increasing coating mechanical stability. Suitable plasticizers include (but are not limited to) polycarboxylic acid alkyl esters or polyethylene glycols or polypropylene glycols.

Preferably the plasticizer comprises citric acid triethyl ester or sebacic acid dibutyl ester or adipic acid diisopropyl ester, diethylene glycol or dipropylene glycol.

Most preferably the plasticizer comprises adipic acid diisopropyl ester or dipropylene glycol. Preferred commercially available examples of such plasticizers include Crodamol DA and DOW Dipropylene Glycol.

Generally the coating is applied in a method in which the coating is solubilised in a solvent, such as water or a single/mixture of organic solvents and dried onto the particle.

A preferred method to apply the coating is via fluid bed processing, either batch or continuous. In this method the particles to be coated are loaded into a fluid bed equipment, fluidised through an air flow and sprayed with a solution containing the coating. Solution spraying can be either bottom spraying or top spraying, depending on specific needs. The sprayed solution is then dried onto the particles by the air flow.

Generally the particle has a particle size of between 10 and 2000 microns, preferably between 100 and 1500 microns and most preferably between 500 and 1000 microns.

Preferably the particle comprises a builder such as an acrylate/acrylic polymer; an enzyme such as a lipase, protease, amylase, mannanase; or a bleaching agent such as sodium percarbonate (PCB), tetra acetyl ethylene diamine (TAED), ε-phtalimido-peroxyhexanoic Acid (PAP).

Preferably the aqueous phase comprises at least 90% by weight of the composition.

The particle preferably comprises at least 0.1% of the composition.

Preferably the composition comprises at least 0.01% by weight surfactant, preferably at least 0.05%, more preferably at least 0.1% and most preferably at least 0.2% by weight.

The cleaning composition desirably includes at least one surfactant selected from anionic, cationic, non-ionic or amphoteric (zwitterionic) surfactants.

The particulate and or aqueous phase of the composition may contain other detergent actives such as bleaching agents, enzymes, builders, perfumes, optical brighteners, soil suspending agents, dye transfer inhibition agents.

According to the second aspect of the invention there is provided the use of a cleaning composition comprising a dispersion, including an acidic aqueous phase and a suspended particle, wherein the particle is coated with an acid stable coating, in a cleaning operation.

It will be understood that features of the first aspect of the invention will be taken to apply mutatis mutandis to the second aspect of the invention.

It has been found that in use the particles coating breaks down due a change in pH.

The use is preferably associated with a washing machine and be for mechanical laundry and/or dishwashing. The use may also be for hand washing e.g. manual laundry.

The invention will now be illustrated with reference to the following non-limiting Example.

### EXAMPLE 1

The following procedure was used for the preparation of a liquid cleaning composition containing builder particles that deliver the active ingredient in the wash bath solely.

An acrylic polymer was granulated and then coated with an acid resistant polymer.

The coating matrix was a copolymer of methoxyethene and maleic anhydride, commercially available as Gantrez AN-169 BF from International Specialty Products.

200 grams of acrylic polymer granules having average size of 200 microns were placed in a Glatt ProCell 5 unit with a GF3 type vessel and fluidised. A 30% w/w aqueous solution of the same acrylic polymer was then bottom sprayed in the fluidisation chamber with spray rate from 15 to 50 g/min until the average particle size grew to 500-1000 microns.

500 grams of acrylic polymer granules having 500-1000 microns average size were placed in a Glatt ProCell 5 unit with an AGT 150 type vessel and fluidised. A 5% w/w of Gantrez AN-169 BF was then top sprayed in the fluidisation chamber with spray rate from 8 to 19 g/min until reaching 15% w/w of coating rate. Coated granules thus obtained consisted of 85% acrylic polymer and 15% Gantrez AN-169 BF.

10 grams of coated granules were then dispersed via mechanical stirring into 990 g of a laundry additive product base containing, among others, oxygen peroxide and anionic and non ionic surfactants, and having a pH between 4 and 5 and a viscosity (at 20° C. and 10 rpm) between 1000 and 2000 cps. Final product appeared like a clear gel with speckles inside.

### EXAMPLE 2

The following procedure was used for the preparation of a liquid cleaning composition containing particles of various ingredients that deliver the active ingredient solely in the wash bath.

A bleach activator (Tetraacetylethylendiamine, TAED), a bleaching agent (ε-Phtalymido-peroxy-hexanoic acid, PAP) and an enzyme (Stainzyme 12T, an amylase), all in granular form having particle size 500-1000 μm, were coated with an acid resistant polymer.

The coating matrix was a copolymer of methyl acrylate, methyl methacrylate and methacrylic acid, commercially available as Eudragit FS 30 D from Evonik.

The coating composition was as follows:

| | | |
|---|---|---|
| Eudragit FS 30 D | 43.0% | w/w |
| Talc | 6.5% | w/w |
| Triethyl citrate | 0.5% | w/w |
| Water | 50.0% | w/w |

600 grams of the particulate components were placed in a Glatt ProCell 5 unit with an AGT 150 type vessel and fluidised. The coating recipe was bottom sprayed in the fluidisation chamber. The spray rate was from 4 to 18 g/min. Spraying was continued until 20% w/w of coating was reached. (The coated granules thus obtained comprised around 80% active ingredient and 20% coating).

Three compositions were created as below using one of the coated particles and a base liquid laundry additive product containing peroxide plus anionic and non ionic surfactants. The base laundry additive product had a pH between 4 and 5 and a viscosity (at 20° C. and 10 rpm) between 1000 and 2000 cps

| | Composition | | |
|---|---|---|---|
| | A | B | C |
| Particulate | 5 g | 12.5 g | 1.5 g |
| | coated | coated | coated |
| | TAED | PAP | enzyme |
| Amount of laundry | 995 g | 987.5 g ** | 998.5 g |
| additive base | | | |

** free of peroxide.

Compositions A, B and C all had the appearance of a clear gel with speckles inside.

Performance Testing

Performance tests were conducted to evaluate the performance of the laundry additive with new ingredients.

Composition C (as shown above) was tested.

Test Conditions

Products dosages/g

1. 95 g Dash Powder+62.1 g base liquid laundry additive product.

2. 95 g Dash Powder+30 g Powder Wash Booster (containing enzyme).

3. 95 g Dash Powder+62.1 g Composition C.

Washing Program: Cotton Intensive (duration 1 h46 min)

Washing Temp.: 40° C.

Wash Load: 3.5 Kg

Washing Machine: BOSCH WAE 24420 IT

Nr. Replicates: 4 external 2 internal

Spectrophotometer: X rite 8400

Drying Method: Line Drying

Standard Soil:

| | |
|---|---|
| CFT C-S-32 | sebum/carbon black |
| empa 101 | olive oil/carbon black |
| empa 141 | lipstick |
| empa 143 | make up |
| WFK 10D | skin grease/pigment |
| WFK 10GM | dirty motor oil |
| CFT C-S-15 | blueberry juice |
| WFK 10J | tea |
| WFK 10K | coffee |
| WFK 10LI | wine |
| WFK 10T | ketchup |
| CFT C-S-08 | grass |
| CFT C-S-27 | potato starch/colorant |
| CFT C-S-28 | rice starch/colorant |

Test Results (Y-Value)

| | Composition | | |
|---|---|---|---|
| Stain | 1 | 2 | 3 |
| Greasy | 52.2 | 52.7 | 52.6 |
| Stains | | | |
| Bleachable | 86.0 | 86.0 | 85.8 |
| Stains | | | |
| Enzymatic | 71.3 | 74.4 | 75.3 |
| Stains | | | |

The results clearly indicate that, on enzymatic stains, Composition C is able to provide a significant stain removal boost compared to an additive without enzymes, reaching the performance of powder laundry additives, containing enzymes.

1. A cleaning composition comprising a dispersion, which comprises an acidic aqueous phase and a suspended particle, wherein the particle is coated with an acid stable coating.

2. A cleaning composition according to claim 1, wherein the coating comprises a copolymer of acrylic acid and acrylic acid methyl ester or a copolymer of methacrylic acid and methacrylic acid methyl ester or a copolymer of methoxyethene and bicarboxylic acids anhydrides or mixtures thereof.

3. A cleaning composition according to claim 1, wherein the coating comprises a copolymer of acrylic acid methyl ester, methacrylic acid methyl ester and methacrylic acid or a copolymer of methoxyethene and maleic anhydride.

4. A cleaning composition according to claim 1 wherein the coating is applied in a method in which the coating is solubilised in a solvent and dried onto the particle.

5. A cleaning composition according to claim 1 wherein the particle has a particle size of between 10 and 2000 microns.

6. A cleaning composition according to claim 1 wherein the particle comprises an acrylic polymer or an enzyme or a bleaching agent.

7. A composition according to claim 1 wherein the aqueous phase comprises at least 90% by weight of the composition.

8. A composition according to claim 1 wherein the particulate comprises at least 0.1% by weight of the composition.

9. (canceled)

10. A cleaning composition according to claim 5, wherein the particle has a particle size of between 100 and 1500 microns.

11. A cleaning composition according to claim 10, wherein the particle has a particle size of between 500 and 1000 microns.

12. A method of washing, which method comprises the step of utilizing a cleaning composition according to claim 1 in the washing method.

13. A method of washing according to claim 12, wherein the method is a hand washing method for the washing of laundry.

14. A method of washing according to claim 12, wherein the method is practiced in a washing machine.
